(19) United States
(12) Patent Application Publication
(10) Pub. No.: US 2025/0362883 A1
(43) Pub. Date: Nov. 27, 2025

(54) INFORMATION PROCESSING APPARATUS, METHOD, AND NON-TRANSITORY COMPUTER-READABLE MEDIUM

(71) Applicant: NEC Corporation, Tokyo (JP)

(72) Inventor: Takayuki KURODA, Tokyo (JP)

(73) Assignee: NEC Corporation, Tokyo (JP)

(21) Appl. No.: 19/203,529

(22) Filed: May 9, 2025

(30) Foreign Application Priority Data
May 24, 2024 (JP) 2024-084520

(51) Int. Cl. G06F 8/20; G06F 40/40

(52) U.S. Cl. CPC G06F 8/20; G06F 40/40

(57) ABSTRACT

An information processing apparatus comprises: at least one memory storing instructions; and at least one processor configured to execute the instructions to; input, to a predetermined language model, a first input text including a first instruction sentence for converting a required specification sentence in which a required specification of software is described in a natural language into a set of sentences in accordance with a predetermined sentence type and the required specification sentence; acquire the set of sentences converted from the required specification sentence based on the first instruction sentence; input, to the language model, a second input text including a second instruction sentence for converting the set of sentences into model data by a software design method based on object orientation and the set of sentences; and acquire model data converted from the set of sentences based on the second instruction sentence.

### INCORPORATION BY REFERENCE

This application is based upon and claims the benefit of priority from Japanese patent application No. 2024-084520, filed on May 24, 2024, the disclosure of which is incorporated herein in its entirety by reference.

### TECHNICAL FIELD

The present disclosure relates to an information processing apparatus, a method, and a non-transitory computer-readable medium.

### BACKGROUND ART

Japanese Unexamined Patent Application Publication No. 2004-287695 discloses a technique for developing an object-oriented language program from a natural language using an ontology engineering technique. For example, in a technique according to Japanese Unexamined Patent Application Publication No. 2004-287695, a basic ontology in which classes, methods, and the like provided by an object-oriented language are managed with vocabulary labels is used. Then, a vocabulary in which a noun included in an input natural language matches a vocabulary label included in a basic ontology is set as a class name.

### SUMMARY

However, in the technique according to Japanese Unexamined Patent Application Publication No. 2004-287695, a class name has to be generated within a range of vocabulary labels defined in the basic ontology generated in advance. Therefore, there is a problem in development efficiency in that there is a limitation on sentences in a natural language written for software development by a developer.

In view of the above-described problems, an example object of the present disclosure is to provide an information processing apparatus, a method, and a non-transitory computer-readable medium for supporting efficient software development based on object orientation from sentences in a natural language written for software development.

In a first example aspect, an information processing apparatus includes:
at least one memory storing instructions; and
at least one processor configured to execute the instructions to;
input, to a predetermined language model, a first input text including a first instruction sentence for converting a required specification sentence in which a required specification of software is described in a natural language into a set of sentences in accordance with a predetermined sentence type and the required specification sentence;
acquire the set of sentences converted from the required specification sentence based on the first instruction sentence by the language model;
input, to the language model, a second input text including a second instruction sentence for converting the set of sentences into model data by a software design method based on object orientation and the set of sentences; and
acquire model data converted from the set of sentences based on the second instruction sentence by the language model.

In a second example aspect, an information processing method is an information processing method performed by an information processing apparatus which includes:
inputting, to a predetermined language model, a first input text including a first instruction sentence for converting a required specification sentence in which a required specification of software is described in a natural language into a set of sentences in accordance with a predetermined sentence type and the required specification sentence;
acquiring the set of sentences converted from the required specification sentence based on the first instruction sentence by the language model;
inputting, to the language model, a second input text including a second instruction sentence for converting the set of sentences into model data by a software design method based on object orientation and the set of sentences; and
acquiring model data converted from the set of sentences based on the second instruction sentence by the language model.

In a third example aspect, a non-transitory computer-readable medium stores a program that causes a computer to execute:
a first input process of inputting, to a predetermined language model, a first input text including a first instruction sentence for converting a required specification sentence in which a required specification of software is described in a natural language into a set of sentences in accordance with a predetermined sentence type and the required specification sentence;
a first acquisition process of acquiring the set of sentences converted from the required specification sentence based on the first instruction sentence by the language model;
a second input process of inputting, to the language model, a second input text including a second instruction sentence for converting the set of sentences into model data by a software design method based on object orientation and the set of sentences; and
a second acquisition process of acquiring model data converted from the set of sentences based on the second instruction sentence by the language model.

According to the present disclosure, efficient software development based on object orientation can be supported from sentences in natural language written for software development.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating an overall configuration of a software development support system including the information processing apparatus according to the present disclosure;

FIG. 4 is a block diagram illustrating a configuration of an information processing apparatus according to the present disclosure;

FIG. 5 is a diagram illustrating an example of a required specification sentence according to the present disclosure;

FIG. 6 is a flowchart illustrating a flow of a software development support method based on object orientation according to the present disclosure;

FIG. 7 is a diagram illustrating an example of a sentence data analysis prompt according to the present disclosure;

FIG. 8 is a diagram illustrating an example of a set of sentences converted from required specification sentences according to the present disclosure;

FIG. 9 is a diagram illustrating an example of a model conversion prompt according to the present disclosure;

FIG. 10 is a diagram illustrating an example of object-oriented model data converted from the set of sentences according to the present disclosure;

FIG. 11 is a diagram illustrating an example of a code conversion prompt according to the present disclosure;

FIG. 12 is a diagram illustrating an example of a source code converted from model data to a specific programming language according to the present disclosure;

FIG. 13 is a diagram illustrating an example of a required specification sentence according to the present disclosure;

FIG. 14 is a flowchart illustrating a flow of a software development support method based on object orientation according to the present disclosure;

FIG. 15 is a diagram illustrating an example of a set of sentences converted from required specification sentences according to the present disclosure;

FIG. 16 is a diagram illustrating an example of object-oriented first model data converted from the set of sentences according to the present disclosure;

FIG. 17 is a diagram illustrating an example of a hierarchization prompt according to the present disclosure;

FIG. 18 is a diagram illustrating an example of second model data hierarchized by abstracting a class from the first model data according to the present disclosure;

FIG. 19 is a diagram illustrating an example of a source code converted from the second model data into a specific programming language according to the present disclosure; and

FIG. 20 is a block diagram illustrating a hardware configuration of the information processing apparatus according to the present disclosure.

### EXAMPLE EMBODIMENT

Hereinafter, example embodiments of the present disclosure will be described in detail with reference to the drawings. In the drawings, the same or correspondent elements are denoted by the same reference numerals, and repeated description thereof will be omitted as necessary to clarify description.

### First Example Embodiment

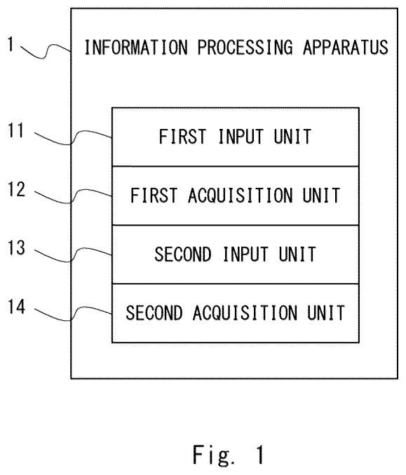

FIG. 1 is a block diagram illustrating a configuration of an information processing apparatus 1. The information processing apparatus 1 is a computer apparatus that generates model data in which software design based on object orientation is performed from a required specification sentence in which a required specification of software is described in a natural language using a predetermined language model. The information processing apparatus 1 may be referred to as a software development support apparatus. The information processing apparatus 1 includes a first input unit 11, a first acquisition unit 12, a second input unit 13, and a second acquisition unit 14. The first input unit 11, the first acquisition unit 12, the second input unit 13, and the second acquisition unit 14 may be used as means for inputting information or data and means for acquiring information or data.

The first input unit 11 inputs a first input text including a first instruction sentence and a required specification sentence to a predetermined language model. Here, the “required specification sentence” is a sentence (text data) in which the required specification of the software is described in a natural language. For example, the required specification sentence may be written by a software developer. Alternatively, the required specification sentence may be text data extracted and generated from a large number of pieces of electronic data for software development. The “first instruction sentence” is a sentence for converting the required specification sentence into a set of sentences in accordance with the predetermined sentence type. A “sentence” is text data including one or more sentences.

Further, the “language model” is a computer program or an information system that receives text data (input text) in which a question or an instruction is expressed in a natural language as an input, and outputs text data subjected to processing such as generation, conversion, processing, and summarization by a predetermined operation on the input text. The language model corresponds to a natural language model in an artificial intelligence (AI) model. It is assumed that the language model is executed in the information processing apparatus 1, an external server connected to the information processing apparatus 1, or the like and can accept the input text. The “instruction sentence” is text data for instructing the language model to execute processing on the required specification sentence. Therefore, the language model executes processing for converting the required specification sentence into a set of sentences in accordance with a predetermined sentence type based on the first instruction sentence, and outputs the set of converted sentences as a processing result.

The first acquisition unit 12 acquires the set of sentences converted from the required specification sentence based on the first instruction sentence by the language model. That is, the first acquisition unit 12 acquires the set of sentences as output data from the language model. Here, the “set of sentences” is text data. The set of sentences is, for example, a set of single sentences in which nouns, predicates, attributes, and the like included in the required specification sentence are divided or converted according to the predetermined sentence type.

The second input unit 13 inputs the second input text including the second instruction sentence and the set of sentences to the language model. Here, the “second instruction sentence” is a sentence for converting a set of sentences into model data by a software design method based on object orientation. The “set of sentences” included in the second input text is text data acquired by the above-described first acquisition unit 12.

The second acquisition unit 14 acquires the model data converted from the set of sentences based on the second instruction sentence by the language model. Here, the “model data” is software design information generated by object-oriented analysis. The model data includes text data with a predetermined format that is an object-oriented analysis result. Further, the model data may include various graphic data of the object-orientated analysis result.

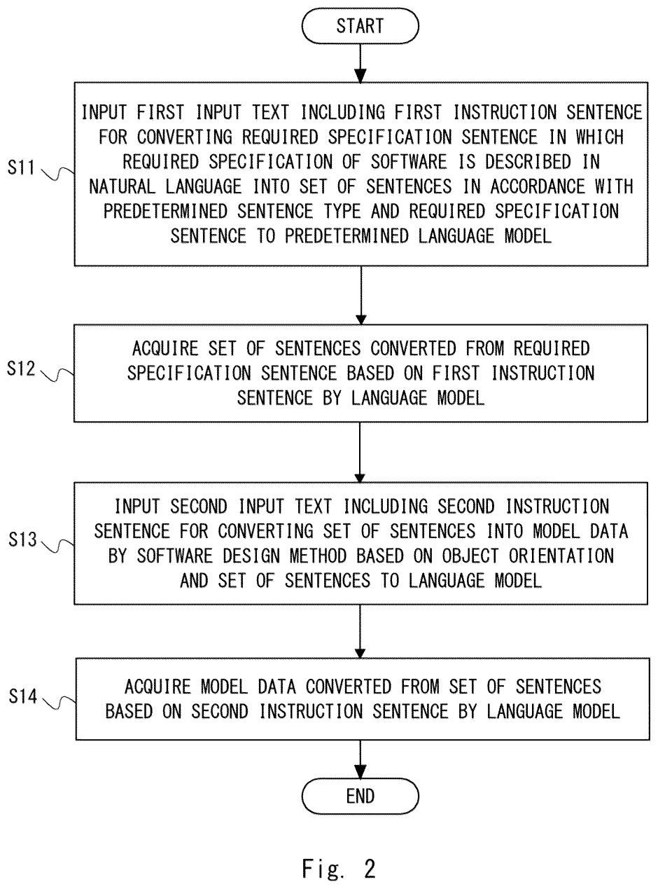

FIG. 2 is a flowchart illustrating a flow of an information processing method. First, the first input unit 11 inputs the first input text including the first instruction sentence and the required specification sentence to the predetermined language model (S11). Here, the required specification sentence is a sentence in which the required specification of the software is described in a natural language. The first instruction sentence is a sentence for converting the required specification sentence into a set of sentences in accordance with the predetermined sentence type. Subsequently, the first acquisition unit 12 acquires the set of sentences converted from the required specification sentence based on the first instruction sentence by the language model (S12).

Subsequently, the second input unit 13 inputs the second input text including the second instruction sentence and the set of sentences to the language model (S13). Here, the set of sentences is acquired in step S12. The second instruction sentence is an instruction sentence for converting the set of sentences into model data by the software design method based on object orientation. Then, the second acquisition unit 14 acquires the model data converted from the set of sentences based on the second instruction sentence by the language model (S14).

As described above, the information processing apparatus 1 converts the required specification sentence into the set of sentences using the language model and converts the set of sentences into the model data subjected to the object-oriented analysis. By inputting an appropriate instruction sentence to the language model during each conversion, it is possible to acquire model data that is design information based on object orientation by utilizing characteristics of the language model. Accordingly, a software developer can efficiently develop desired software using the acquired model data. Therefore, the information processing apparatus 1 according to the present disclosure can support efficient software development based on object orientation from the sentences in the natural language written for software development.

The information processing apparatus 1 includes a processor, a memory, and a storage device as a configuration (not illustrated). The storage device stores, for example, a computer program in which processing of an information processing method of FIG. 2 is implemented. The processor reads the computer program or the like from the storage device on the memory and executes the computer program. Accordingly, the processor realizes functions of the first input unit 11, the first acquisition unit 12, the second input unit 13, and the second acquisition unit 14.

Alternatively, each constituent of the information processing apparatus 1 may be realized by dedicated hardware. Some or all of the constituents of each apparatus may be realized by a general-purpose or dedicated circuitry, a processor, or a combination thereof. These constituents may be configured with a single chip or may be configured with a plurality of chips connected via a bus. Some or all of the constituents of each apparatus may be realized by a combination of the above circuitry or the like and a program. As the processor, a central processing unit (CPU), a graphics processing unit (GPU), a field-programmable gate array (FPGA), a quantum processor (quantum computer control chip), or the like can be used.

In a case where some or all of the constituents of the information processing apparatus 1 are realized by a plurality of information processing apparatuses, circuitry, or the like, the plurality of information processing apparatuses, circuitry, or the like may be centralized or distributed. For example, the information processing apparatus, the circuitry, and the like may be realized as a form of a system in which each of a client server system and a cloud computing system are connected via a communication network. The functions of the information processing apparatus 1 may be provided in software as a service (Saas) format.

### Second Example Embodiment

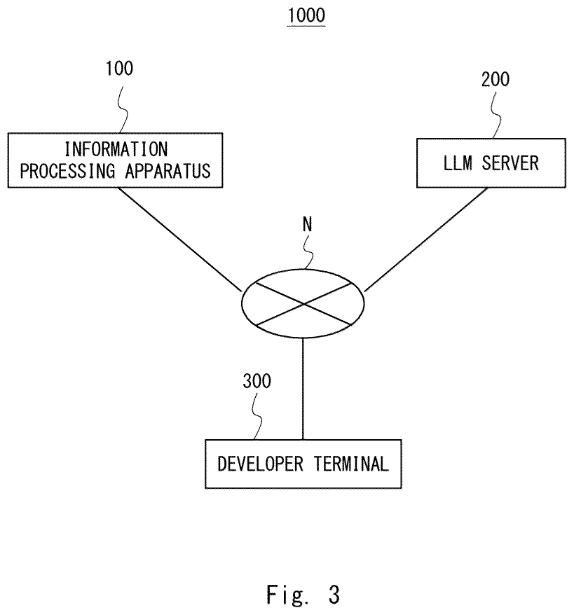

FIG. 3 is a block diagram illustrating an overall configuration of a software development support system 1000 including the information processing apparatus 100. The software development support system 1000 is an information system that supports software development by automatically generating model data and source code of software based on object orientation from a sentence described in a natural language using a language model. The software development support system 1000 includes the information processing apparatus 100, a large language model (LLM) server 200, and a developer terminal 300. The information processing apparatus 100, the LLM server 200, and the developer terminal 300 are each communicatively connected via a network N. Here, the network N is a wired and/or wireless communication line network.

The developer terminal 300 is an information processing apparatus operated by a developer who develops software based on object orientation. The developer terminal 300 may be a general-purpose personal computer (PC) or the like. Therefore, the developer terminal 300 executes processing in response to an operation of a keyboard or a mouse by the developer and communicates with the information processing apparatus 100 via the network N as appropriate.

The LLM server 200 is a server computer on which a predetermined LLM operates. The LLM is an example of a language model in the above-described first example embodiment. The LLM is a trained model that is trained by repeating deep learning using a large data set on a predetermined natural language model. In the LLM, the number of times deep learning is executed, the number of data sets used for learning, and the number of parameters to be learned are larger than those at the time AI models started to spread. Therefore, the LLM may be referred to as a large-scale language model. The LLM is a computer program that accepts an input text (prompt) described in a specific format as an input, executes processing based on an instruction sentence included in the prompt, and outputs a processing result. Here, the prompt includes text data that is a processing target and an instruction sentence in which processing on the text data is described in a specific format.

For example, it is assumed that the first instruction sentence is an instruction to convert sentence data in a natural language into a set of sentences in accordance with a predetermined sentence type such as basic five sentence types of English grammar. In this case, the LLM converts the sentence data in the natural language included in a prompt into a set of sentences in accordance with a predetermined sentence type according to the first instruction sentence included in the input prompt. For example, in a case where the sentence data is “A user logs in and reserves a ticket”, the LLM extracts a subject (User), a predicate (Log in and Reserve), an object (Ticket), and the like from the sentence data and converts the sentence data into a set of two sentences of “A user logs in” and A user reserves a ticket”.

Next, it is assumed that the second instruction sentence is an instruction to convert a set of sentences into model data by an object-oriented software design method. In this case, the LLM extracts components (classes, methods, members (attributes, properties), arguments, return values, and the like) of the object-oriented software from the set of the converted sentences in accordance with the second instruction sentence included in the input prompt, and generates the model data by organizing relationships (inheritance, possession, correspondence, and the like). For example, in the case of the set of the converted sentences described above, an LLM defines “User” and “Ticket” as classes, causes the “User” class to have methods “Log in” and “Reserve”, and converts the “Reserve” method into model data defining the “Ticket” class as an argument.

Thereafter, it is assumed that the third instruction sentence is an instruction to convert the model data into the source code based on the specification of the specific programming language. In this case, the LLM converts the above converted model data into source codes in accordance with the specification of a specific programming language in accordance with the third instruction sentence included in the input prompt. Accordingly, the source codes of the software based on the object orientation can be automatically generated from the sentence in the natural language using the LLM.

Therefore, it can be said that the LLM functions as a sentence data analysis unit and a model generation unit. Here, the sentence data analysis unit analyzes sentence data in a natural language, generates a plurality of sentences according to a plurality of basic sentence types in a grammar of a specific natural language, and generates a set of sentences. The model generation unit converts a set of sentences into model data that is information defining components of software based on object orientation and a relationship between the components.

In a case where an input text (prompt) is accepted from the request source via the network N, the LLM server 200 inputs the prompt to the LLM and returns output data that is a processing result obtained by the LLM to the request source via the network N. A request source is, for example, the information processing apparatus 100 or the developer terminal 300.

The information processing apparatus 100 is an example of the above-described information processing apparatus 1. The information processing apparatus 100 is a computer apparatus that generates model data and a source code of software based on object orientation from a sentence described in a natural language using an LLM. Specifically, the information processing apparatus 100 receives an instruction of software development support processing based on the required specification sentence and the object orientation from the developer terminal 300 via the network N. Then, the information processing apparatus 100 communicates with the LLM server 200 in order to generate the model data and the source code of the software based on the object orientation from the required specification sentence. Specifically, the information processing apparatus 100 generates an LLM prompt, transmits (inputs) the prompt to the LLM server 200, and receives (acquires) output data from the LLM server 200 a plurality of times according to each stage of software development based on the object orientation.

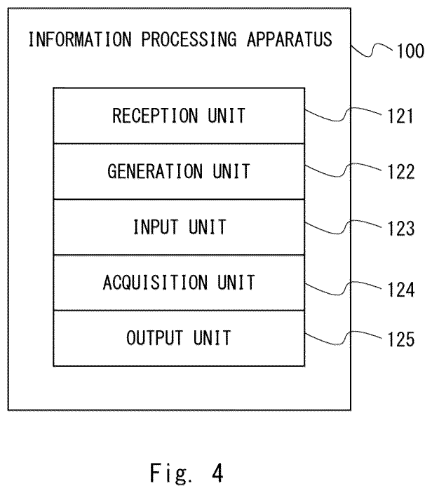

FIG. 4 is a block diagram illustrating a configuration of the information processing apparatus 100. The information processing apparatus 100 includes a reception unit 121, a generation unit 122, an input unit 123, an acquisition unit 124, and an output unit 125. The reception unit 121, the generation unit 122, the input unit 123, the acquisition unit 124, and the output unit 125 may be used as means for receiving information or data, means for generating information or data, means for inputting information or data, means for acquiring information or data, and means for outputting information or data, respectively.

The reception unit 121 receives an instruction of the software development support processing based on the required specification sentence and the object orientation from the developer terminal 300 via the network N. The reception unit 121 may receive various prompts to be described below from the developer terminal 300. The reception unit 121 may receive a set of corrected sentences or corrected model data, a part of a set of sentences or a part of the model data from the developer terminal 300 as processing targets.

The generation unit 122 generates a sentence analysis prompt including the first instruction sentence and the required specification sentence. The sentence analysis prompt is an example of the above-described first input text. The generation unit 122 generates a model conversion prompt including the second instruction sentence and the set of sentences. The model conversion prompt is an example of the second input text described above. Here, the set of sentences included in the model conversion prompt is a set of sentences converted from the required specification sentence by the LLM based on the above-described sentence analysis prompt. The generation unit 122 generates a code conversion prompt including the third instruction sentence and the model data. The code conversion prompt is an example of the third input text. Here, the model data included in the code conversion prompt is data converted from the set of sentences by the LLM based on the above-described code conversion prompt. The “third instruction sentence” is a sentence for converting the model data into a source code based on a specification of a specific programming language.

The input unit 123 is an example of the above-described first input unit 11 and second input unit 13. The input unit 123 inputs the sentence analysis prompt generated by the generation unit 122 to the LLM. The input unit 123 inputs the model conversion prompt generated by the generation unit 122 to the LLM. The input unit 123 is also an example of third input means. The input unit 123 inputs the third input text including the third instruction sentence and the model data to the language model. That is, the input unit 123 inputs the code conversion prompt generated by the generation unit 122 to the LLM. Specifically, the input unit 123 inputs each prompt to the LLM by transmitting each prompt to the LLM server 200 via the network N.

The acquisition unit 124 is an example of the above-described first acquisition unit 12 and second acquisition unit 14. The acquisition unit 124 acquires the set of sentences converted by the LLM in response to the sentence analysis prompt as output data. Here, the set of sentences is converted from the required specification sentence by the LLM in accordance with a plurality of basic sentence types in the grammar of a specific natural language. The acquisition unit 124 acquires the model data converted by the LLM in response to the model conversion prompt as output data. The acquisition unit 124 is also an example of third acquisition means. The acquisition unit 124 acquires the source code converted from the model data based on the code conversion prompt by the LLM.

The output unit 125 outputs the output data acquired by the acquisition unit 124. For example, the output unit 125 may display output data on a display device contained in or connected to the information processing apparatus 1. Specifically, the output unit 125 may cause the developer terminal 300 to display the output data by transmitting the output data to the developer terminal 300 via the network N.

(Example of Use Case of Software Development Support Processing Based on Object Orientation)

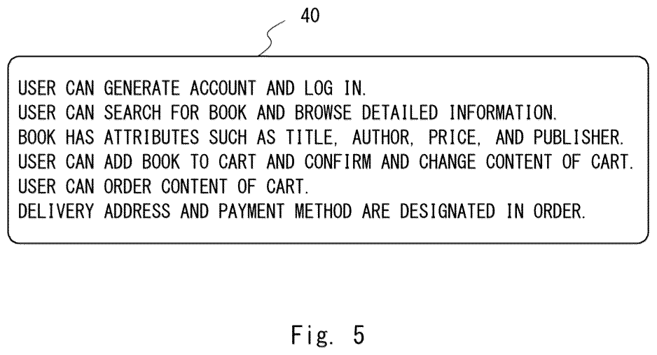

For example, it is assumed that a developer develops a web application of a certain online bookstore. In the online bookstore, it is assumed that the user can search and browse a book, and can add the book to a cart and order the book. Accordingly, it is assumed that the developer of the web application inputs a sentence for describing a required specification for developing software based on object orientation to the developer terminal 300. FIG. 5 is a diagram illustrating an example of a required specification sentence 40.

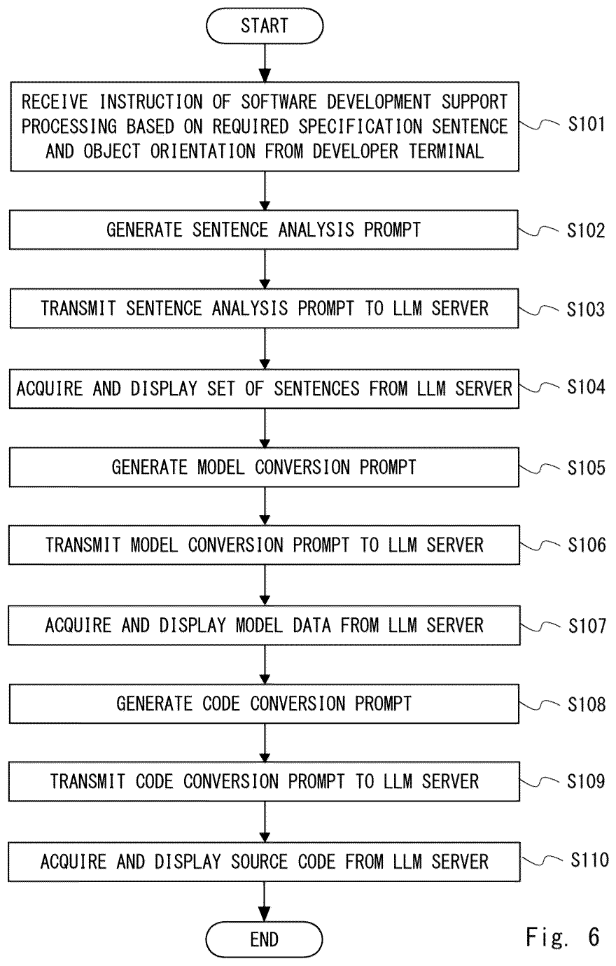

FIG. 6 is a flowchart illustrating a flow of a software development support method based on object orientation. First, the developer terminal 300 transmits a request including the input required specification sentence and the instruction of the software development support processing based on the object orientation to the information processing apparatus 100 via the network N in response to the operation of the developer. Accordingly, the information processing apparatus 1 receives the request from the developer terminal 300 via the network N.

Specifically, the reception unit 121 receives the instruction of the software development support processing based on the required specification sentence and the object orientation from the developer terminal 300 (S101). Then, in response to the received instruction, the generation unit 122 generates the sentence analysis prompt using the received required specification sentence (S102).

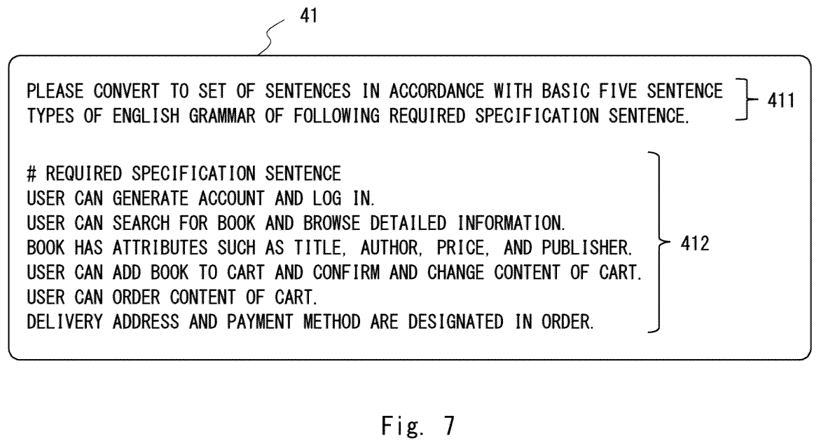

FIG. 7 is a diagram illustrating an example of a sentence data analysis prompt 41. The sentence data analysis prompt 41 is text data including an instruction sentence 411 and a required specification sentence 412. The instruction sentence 411 is an example of the above-described first instruction sentence, and the present disclosure is not limited thereto. For example, the portion of “basic five sentence types of English grammar” in the instruction sentence 411 may be replaced with another natural language or the number of sentence types as long as the portion is a plurality of basic sentence types in the grammar of a specific natural language. For example, a technique such as syntax analysis or morphological analysis (a relationship between a part of speech and a modification) of Japanese may be used to analyze sentence types in the grammar of a specific natural language. The required specification sentence 412 is an example of text data in which the notation of “#required specification sentence” is described at the beginning and the above-described required specification sentence 40 is described after the next line.

Subsequently, the input unit 123 transmits the sentence data analysis prompt 41 to the LLM server 200 (S103). Accordingly, the LLM server 200 inputs the received sentence data analysis prompt 41 to the LLM. The LLM extracts nouns, predicates, attributes, and the like of the required specification sentence 412 based on the instruction sentence 411 included in the sentence data analysis prompt 41. At this time, the LLM may eliminate duplication including a variation in notation from the extracted nouns, predicates, attributes, and the like and aggregate the extracted nouns, predicates, attributes, and the like. Then, the LLM generates a plurality of single sentences from the extracted or aggregated nouns, predicates, attributes, and the like. Therefore, the LLM converts the required specification sentence 412 into a set of sentences. The LLM server 200 transmits an output message including a set of sentences converted by the LLM to the information processing apparatus 100 via the network N.

Accordingly, the acquisition unit 124 acquires an output message including the set of sentences from the LLM server 200. Then, the output unit 125 displays the output message on the developer terminal 300 (S104). Specifically, the output unit 125 transmits the acquired output message to the developer terminal 300 via the network N. Then, the developer terminal 300 displays the received output message on the screen.

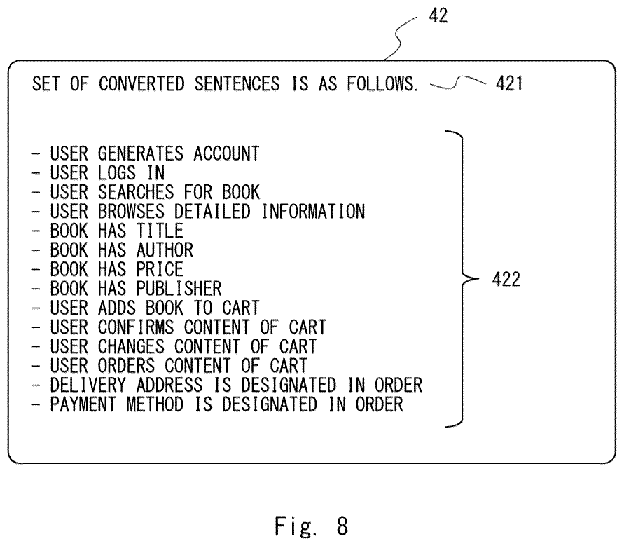

FIG. 8 is a diagram illustrating an example of a set of sentences 422 converted from the required specification sentence 40. The output data 42 is an example of an output message 421 and a set of sentences 422 displayed on the screen of the developer terminal 300. The output message 421 is text data added by the LLM during conversion into a set of sentences. The set of sentences 422 is an example of the text data indicating the set of the plurality of single sentences converted from the required specification sentence 40 by the LLM.

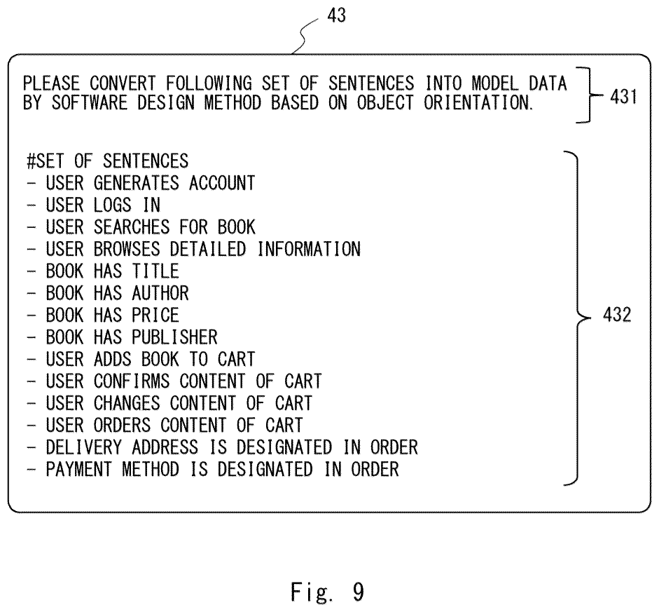

Subsequently, the generation unit 122 generates the model conversion prompt using the acquired set of sentences 422 (S105). FIG. 9 is a diagram illustrating an example of a model conversion prompt 43. The model conversion prompt 43 is text data including an instruction sentence 431 and a set of sentences 432. The instruction sentence 431 is an example of the above-described second instruction sentence, and the present disclosure is not limited thereto. The set of sentences 432 is an example of text data in which the notation of “#set of sentences” is described at the beginning and the above-described set of sentences 422 is described after the next line.

Subsequently, the input unit 123 transmits the model conversion prompt 43 to the LLM server 200 (S106). Accordingly, the LLM server 200 inputs the received model conversion prompt 43 to the LLM. The LLM organizes the set of sentences 432 by abstracting, hierarchizing, and aggregating similar nouns, predicates, attributes, and the like based on the instruction sentence 431 included in the model conversion prompt 43. Then, the LLM generates a class structure by associating the organized nouns, predicates, attributes, and the like with each other. That is, the LLM converts the set of sentences into model data that is information defining components of software based on object orientation and a relationship between the components. Further, the model data may include information in which the components determined to have high similarity in logical structure among the components extracted from the set of sentences by the LLM are abstracted, the components are hierarchically structured, and a relationship between the components is defined. Further, the model data may include a class structure in which words included in the set of sentences are associated with each other. Further, the model data includes classes, methods, attributes, arguments, and return values as components. The model data may include an inheritance relationship between the classes, a possession relationship between the classes, a correspondence relationship between a class and a method, and a correspondence relationship between a method, an argument, and return values as the relationship between the components. The LLM server 200 transmits an output message including the model data converted by the LLM to the information processing apparatus 100 via the network N.

Accordingly, the acquisition unit 124 acquires the output message including the model data from the LLM server 200. Then, the output unit 125 displays the output message on the developer terminal 300 (S107). Specifically, the output unit 125 transmits the acquired output message to the developer terminal 300 via the network N. Then, the developer terminal 300 displays the received output message on the screen.

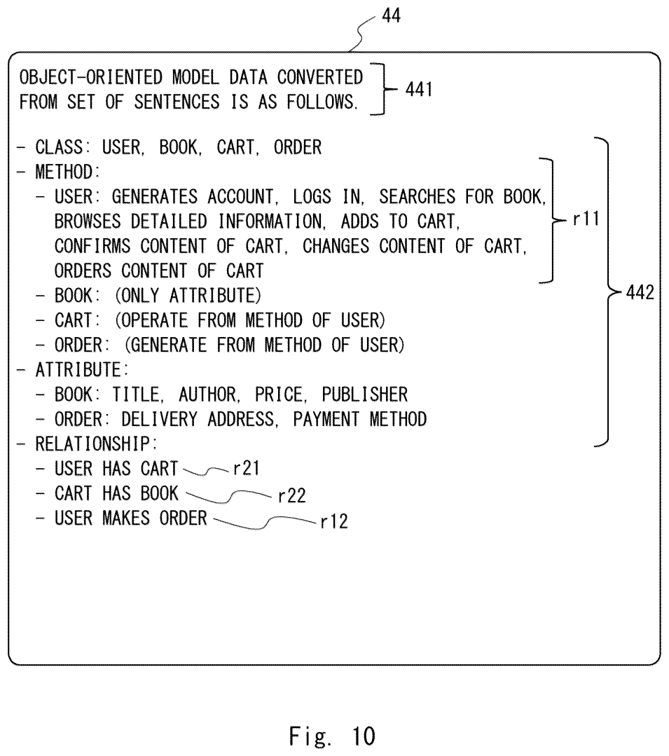

FIG. 10 is a diagram illustrating an example of an object-oriented model data 442 converted from a set of sentences. Output data 44 is an example of an output message 441 and model data 442 displayed on the screen of the developer terminal 300. The output message 441 is text data added by the LLM during conversion into the model data. The model data 442 is text data that is converted from the set of sentences 432 by the LLM and indicates information in which components of software based on object orientation and a relationship between the components are defined. That is, the model data 442 indicates an example converted from the required specification sentence 40 by the object-oriented software design method. The model data 442 may include graphic information such as a class diagram. In that case, for example, the model conversion prompt may include designation of a Mermaid syntax. Relationships r11 and r12 are examples of correspondences between classes and methods.

Relationships r21 and r22 are examples of a possession relationship (has-a relationship) between classes.

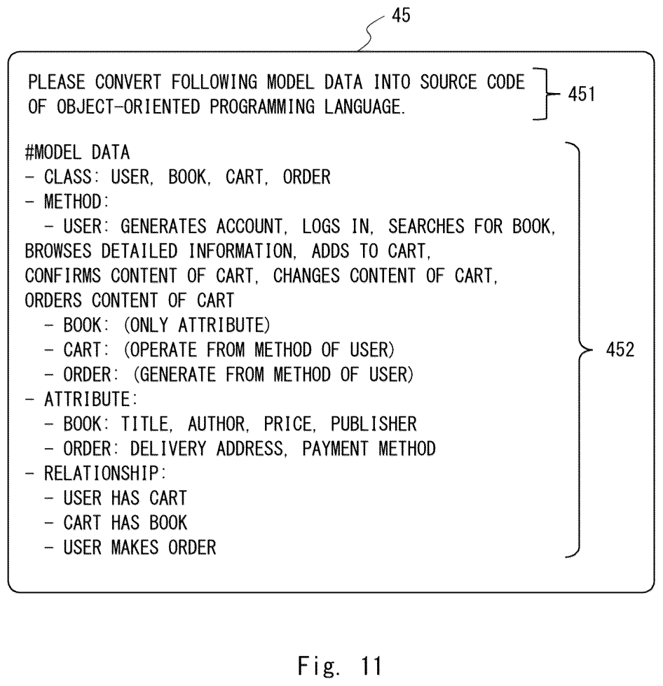

Subsequently, the generation unit 122 generates a code conversion prompt using the acquired model data 442 (S108). FIG. 11 is a diagram illustrating an example of a code conversion prompt 45. The code conversion prompt 45 is text data including an instruction sentence 451 and model data 452. The instruction sentence 451 is an example of the above-described third instruction sentence, and the present disclosure is not limited thereto. In particular, in the instruction sentence 451, a specific language name, for example, “Java (registered trademark)”, may be described instead of the description of the “object-oriented programming language”. The same applies to the following description. The model data 452 is an example of text data in which the notation of “#model data” is written at the beginning and the above-described model data 442 is described after the next line.

Subsequently, the input unit 123 transmits the code conversion prompt 45 to the LLM server 200 (S109). Accordingly, the LLM server 200 inputs the received code conversion prompt 45 to the LLM. The LLM converts the model data 442 into the source code based on the specification of the designated programming language based on the instruction sentence 451 included in the code conversion prompt 45. The LLM server 200 transmits an output message including the source code converted by the LLM to the information processing apparatus 100 via the network N.

Accordingly, the acquisition unit 124 acquires an output message including the source code from the LLM server 200. Then, the output unit 125 displays the output message on the developer terminal 300 (S110). Specifically, the output unit 125 transmits the acquired output message to the developer terminal 300 via the network N. Then, the developer terminal 300 displays the received output message on the screen.

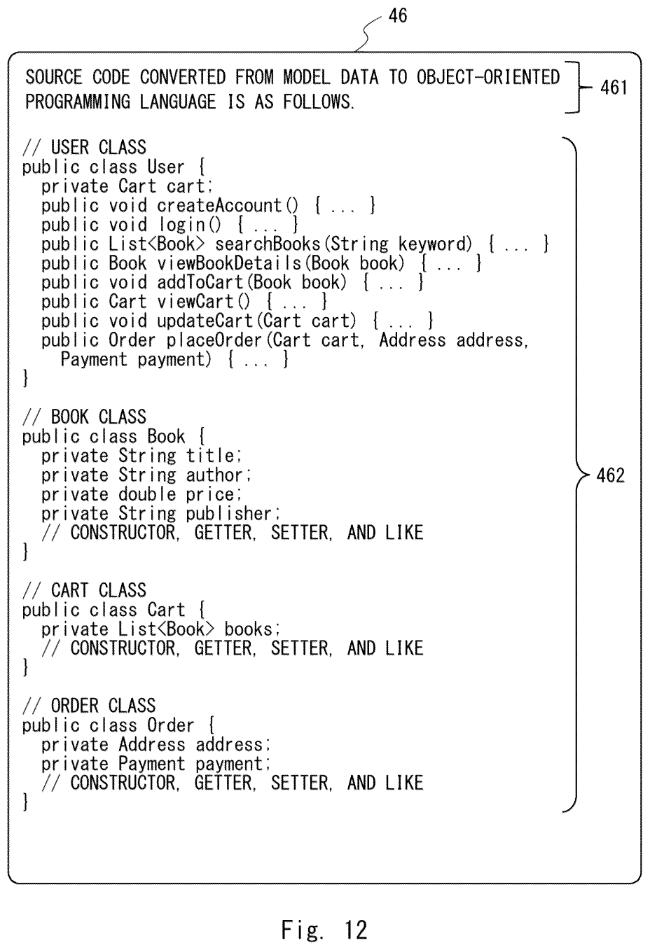

FIG. 12 is a diagram illustrating an example of a source code 462 converted from the model data 452 into a specific programming language. Output data 46 is an example of an output message 461 and a source code 462 displayed on the screen of the developer terminal 300. The output message 461 is text data added by the LLM during conversion into the source code. The source code 462 is an example of a Java (registered trademark) language that is an object-oriented programming language, but the programming language to be converted is not limited thereto. The same applies to the following description. The source code 462 indicates an example in which members (attributes), methods, and the like are implemented for each of the classes User, Book, Cart, and Order. That is, the source code 462 indicates an example generated based on the required specification sentence 40.

The notations of the beginning of the required specification sentence 412 in FIG. 7, the set of sentences 432 in FIG. 9, and the model data 452 in FIG. 11 described above are not limited thereto. For example, the notation of the beginning of the required specification sentence 412, the set of sentences 432, and the model data 452 may be another notation according to the notation of the LLM prompt provided by the LLM server 200. Alternatively, the notation of the beginning of the required specification sentence 412, the set of sentences 432, and the model data 452 may be omitted. In this case, the required specification sentence 412 may be the same sentence as the required specification sentence 40. The set of sentences 432 may be the same sentence as the set of sentences 422. The model data 452 may be the same sentence as the model data 442.

As described above, the technique according to the present disclosure can automate and improve efficiency of analysis and design work considerably at an initial stage of software development by combining natural language processing by the LLM and object-oriented analysis processing step by step. Therefore, the developer can obtain software design with certain granularity only by describing an idea (required specification) of software in a natural language. Accordingly, a burden on the software developer can be greatly reduced.

That is, the technique according to the present disclosure can automatically generate at least a part of software design and code based on object orientation from the required specification expressed in the natural language using a language model. Therefore, the developer can add a detailed specification and correct or extend the generated source code based on the generated model data and the source code. Accordingly, software development work based on object orientation can be made efficiently.

In particular, by using the technique according to the present disclosure, it is possible to automatically infer what kind of class or method is required. Therefore, man-hours at the initial stage of design can be greatly reduced. Accordingly, the developer can focus on implementation of more essential logic. Since a gap between the required specification of the natural language and implementation of software can be reduced, there is a possibility of improving quality and maintainability of the software. Additionally, according to the present embodiment, it is possible to obtain the same effects as those of the above-described first embodiment.

### Third Example Embodiment

In a third embodiment, second model data is acquired by causing an LLM to further abstract (convert) the first model data converted by the LLM. That is, the input unit 123 inputs fourth input text including a fourth instruction sentence and first model data to a predetermined language model. Here, the “first model data” is model data acquired by the acquisition unit 124. The “fourth instruction sentence” is a sentence for abstracting a sentence in which the language model determines that similarity of the logical structure is high among the components included in the first model data, and reconverting components so that components are hierarchically structured. The acquisition unit 124 acquires, as the model data, second model data reconverted from the first model data based on the fourth instruction sentence by the language model to which the fourth input text is input. Accordingly, it is possible to improve accuracy of the object-oriented analysis in the model data. The other configurations according to the third example embodiment are the same as those of the above-described second example embodiment, and thus repeated description and illustration thereof will be omitted as appropriate. Hereinafter, differences from the second example embodiment will be mainly described.

### Example of Use Case of Abstraction

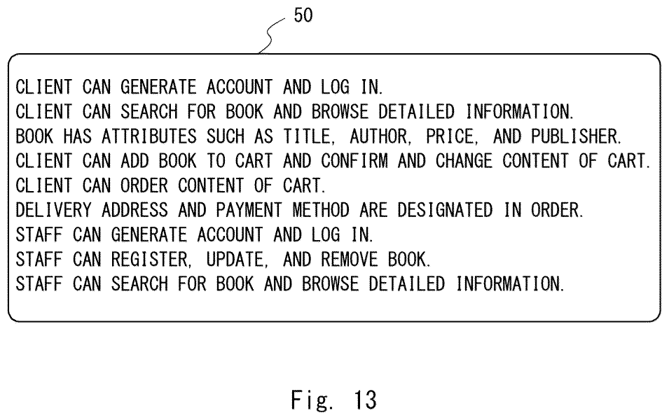

For example, it is assumed that a developer develops a web application of a certain online bookstore. In the online bookstore, it is assumed that a staff registers a book, and a client searches for and browses the book, and adds the book to a cart so that the book can be ordered. Accordingly, it is assumed that the developer of the web application inputs a sentence for describing a required specification for developing software based on object orientation to the developer terminal 300. FIG. 13 is a diagram illustrating an example of a required specification sentence 50. The example of the required specification sentence 50 indicates that processes that can be executed by the staff and the client partially overlap.

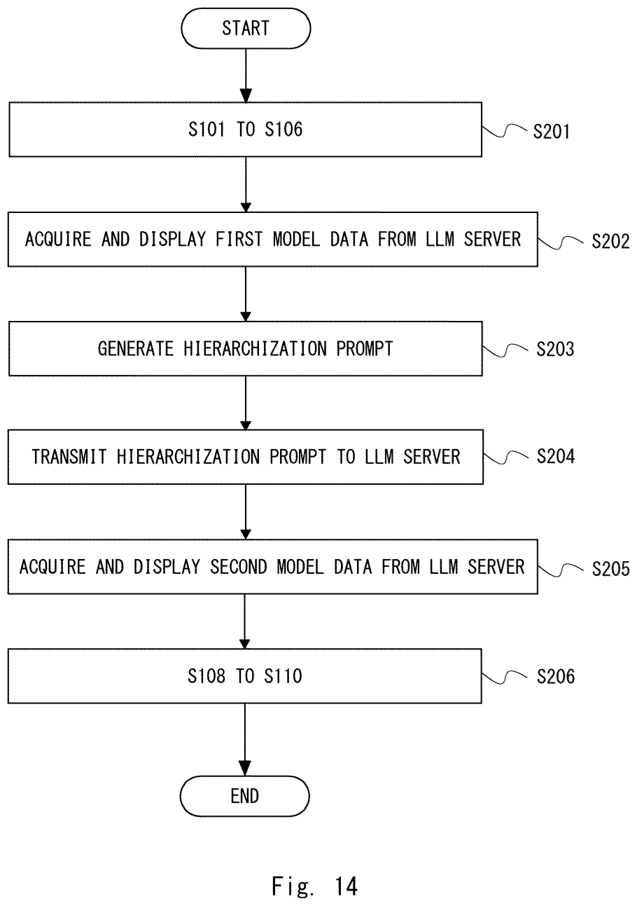

FIG. 14 is a flowchart illustrating a flow of a software development support method based on object orientation. First, the developer terminal 300 transmits a request including the above-described required specification sentence 50 and an instruction of software development support processing based on object orientation to the information processing apparatus 100 via the network N. Accordingly, the information processing apparatus 100 executes steps S101 to S106 in FIG. 6 described above (S201). At this time, in step S102, the generation unit 122 generates a sentence analysis prompt using the required specification sentence 50. In step S104, the acquisition unit 124 acquires a set of sentences converted from the required specification sentence 50 by the LLM, and the output unit 125 causes the developer terminal 300 to display an output message.

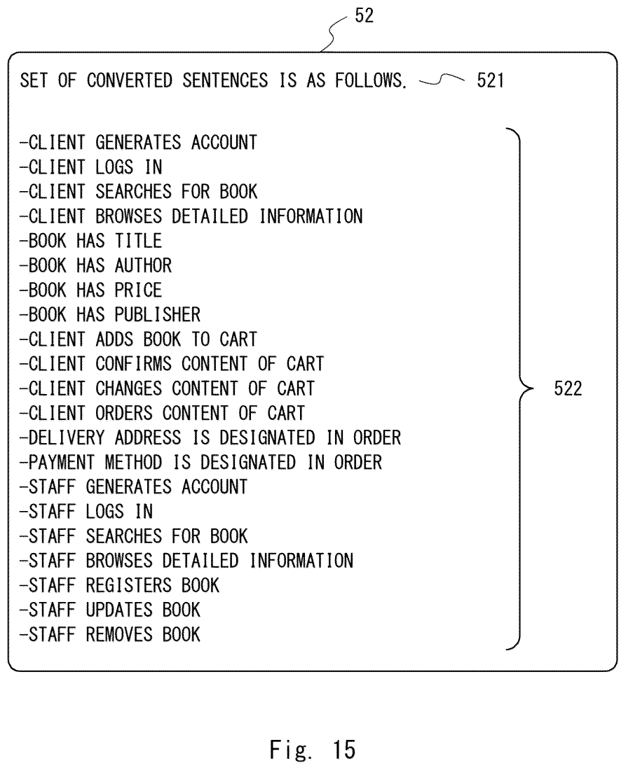

FIG. 15 is a diagram illustrating an example of a set of sentences 522 converted from the required specification sentence 50. The output data 52 is an example of an output message 521 and a set of sentences 522 displayed on the screen of the developer terminal 300. The output message 521 is text data added by the LLM during conversion into a set of sentences. The set of sentences 522 is an example of text data indicating a set of a plurality of single sentences converted from the required specification sentence 50 by the LLM. The set of sentences 522 indicates that the sentences “Client is . . . ” and “Staff is . . . ” are different from the set of sentences 422 in FIG. 8 described above.

Subsequently, in step S105, the generation unit 122 generates a model conversion prompt using the acquired set of sentences 522. Then, in step S106, the input unit 123 transmits a model conversion prompt to the LLM server 200. Then, the acquisition unit 124 acquires an output message including the first model data from the LLM server 200. Then, the output unit 125 displays the output message on the developer terminal 300 (S202).

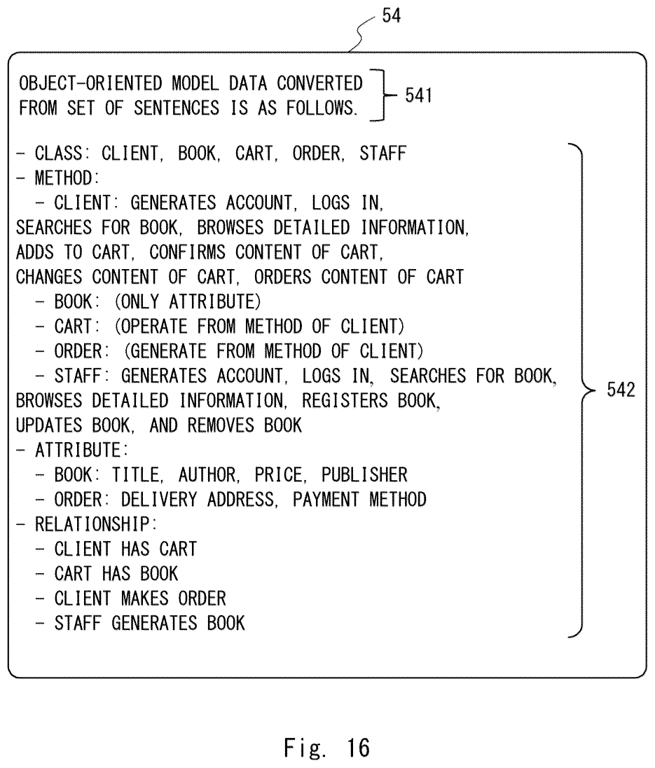

FIG. 16 is a diagram illustrating an example of the object-oriented first model data 542 converted from the set of sentences 522. The output data 54 is an example of the output message 541 and the first model data 542 displayed on the screen of the developer terminal 300. The output message 541 is text data added by the LLM during conversion into the first model data. The first model data 542 is text data indicating information in which components of software based on object orientation and a relationship between the components converted from the set of sentences 522 by LLM are defined. That is, the first model data 442 indicates an example converted from the required specification sentence 50 by the object-oriented software design method. The first model data 442 indicates that the class “user” has been changed to the classes “client” and “staff”, and the methods and the relationship have also been changed as compared with the above-described model data 442 in FIG. 10.

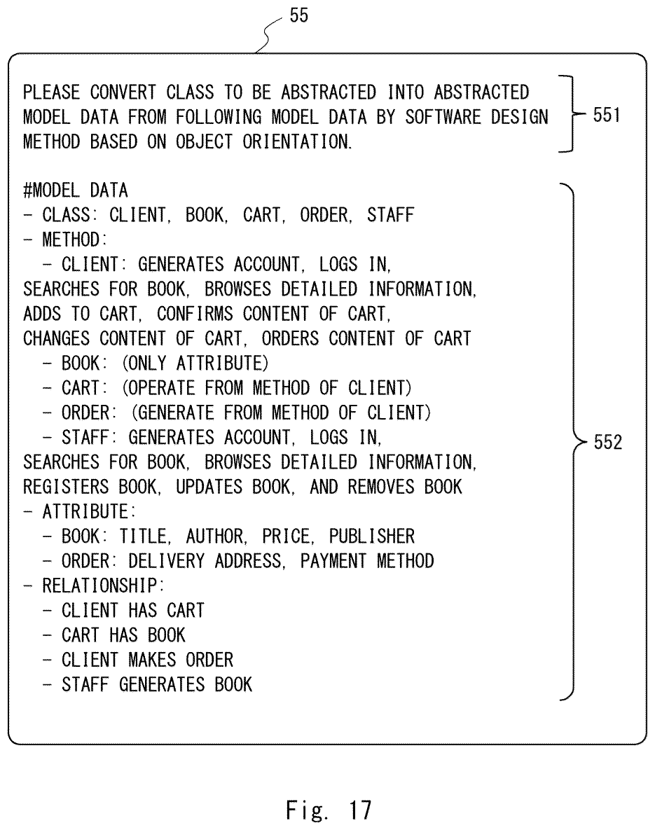

Subsequently, the generation unit 122 generates a hierarchization prompt using the acquired first model data 542 (S203). FIG. 17 is a diagram illustrating an example of a hierarchization prompt 55. The hierarchization prompt 55 is text data including an instruction sentence 551 and a first model data 552. The instruction sentence 551 is an example of the above-described fourth instruction sentence, and the present disclosure is not limited thereto. The first model data 552 is an example of text data in which the notation of “#model data” is written at the beginning and the first model data 542 described above is described after the next line.

Subsequently, the input unit 123 transmits the hierarchization prompt 55 to the LLM server 200 (S204). Accordingly, the LLM server 200 inputs the received hierarchization prompt 55 to the LLM. The LLM generates a superclass in which a plurality of classes is abstracted from the first model data 552 based on the instruction sentence 551 included in the hierarchization prompt 55, corrects methods, attributes, relationships, and the like using each of the original classes as a subclass, and converts the subclasses into the second model data. The LLM server 200 transmits an output message including the second model data converted by the LLM to the information processing apparatus 100 via the network N.

Accordingly, the acquisition unit 124 acquires an output message including the second model data from the LLM server 200. Then, the output unit 125 displays the output message on the developer terminal 300 (S205).

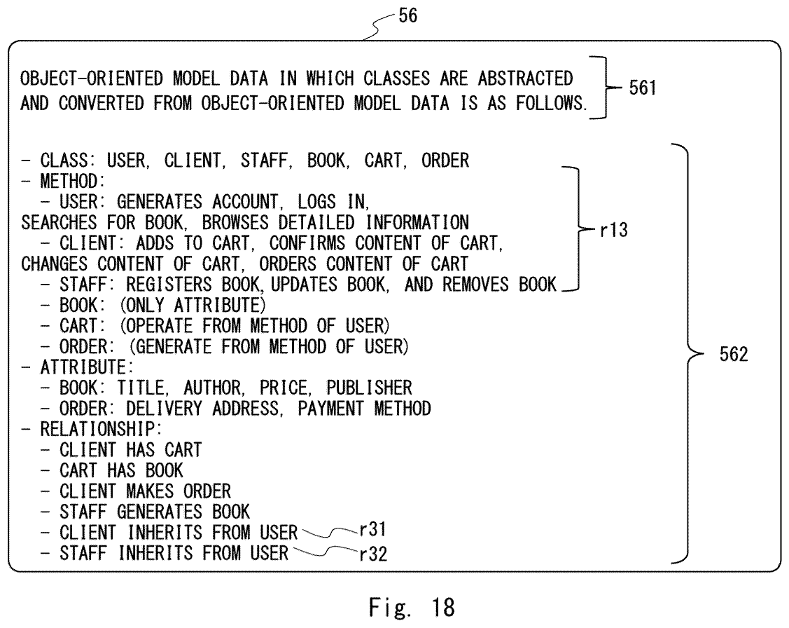

FIG. 18 is a diagram illustrating an example of second model data 562 in which classes are abstracted and hierarchized from the first model data 552. The output data 56 is an example of an output message 561 and model data 562 displayed on the screen of the developer terminal 300. The output message 561 is text data added by the LLM during conversion into the second model data. The second model data 562 is text data indicating information in which classes are abstracted and hierarchized from the first model data 552 by the LLM.

Specifically, the second model data 562 indicates that the superclass “user” obtained by abstracting the classes “client” and “staff” is added. As a result, the second model data 562 indicates that a relationship r13, a relationship r31, and a relationship r32 are changed from the first model data 552. That is, as the relationship r13, the methods “Generate account”, “Log in”, “Search book”, and “Browse detailed information” common to the classes “client” and “staff” are now methods of the superclass “user”. As a result, the relationship r13 indicates that these methods are removed from the subclasses “client” and “staff”. The relationships r31 and r32 are examples of an inheritance relationship (is-a relationship) between classes. Specifically, the relationship r31 indicates that the subclass “client” is in a relationship of inheritance from the superclass “user”. The relationship r32 indicates that the subclass “staff” is in a relationship of inheritance from the superclass “user”.

Subsequently, the information processing apparatus 100 executes steps S108 to S110 of FIG. 6 described above (S206). In step S108, the generation unit 122 generates a code conversion prompt using the acquired second model data 562. In step S109, the input unit 123 transmits the code conversion prompt to the LLM server 200. In step S110, the acquisition unit 124 acquires an output message including the source code from the LLM server 200. The output unit 125 displays the output message on the developer terminal 300.

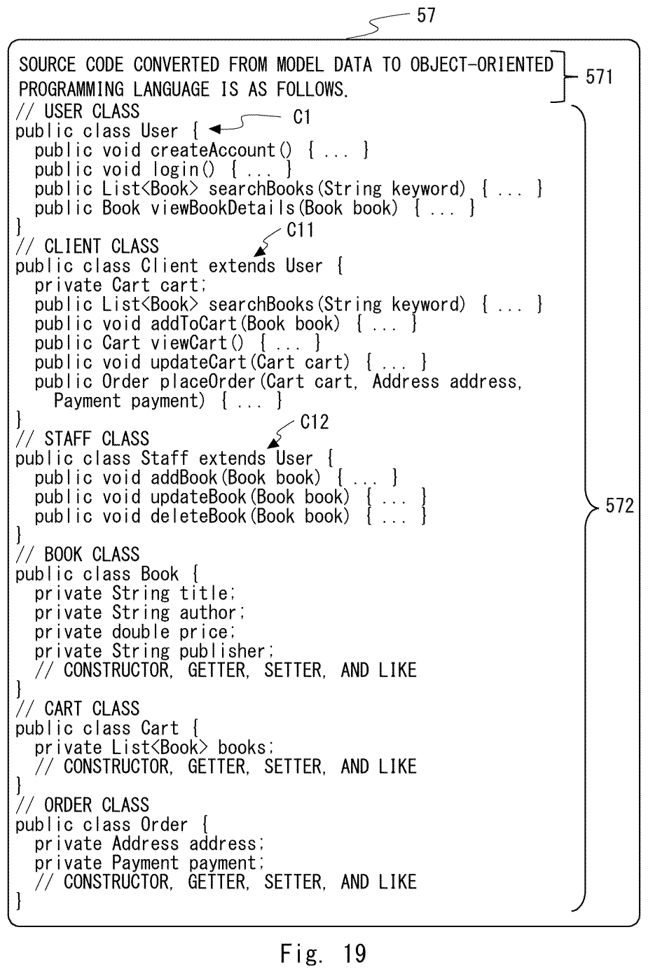

FIG. 19 is a diagram illustrating an example of a source code converted from the second model data 562 into a specific programming language. Output data 57 is an example of an output message 571 and a source code 572 displayed on the screen of the developer terminal 300. The output message 571 is text data added by the LLM during conversion into the source code. The source code 572 shows an example in which a subclass C11 “Client” and a subclass C12 “Staff” inherit a superclass C1 “User”, and a member (attribute), a method, and the like are implemented. That is, the source code 572 shows an example in which classes are abstracted from the first model data generated based on the required specification sentence 50 and converted (from the second model data).

In this way, by the technique according to the present disclosure, the second model data can be acquired by further abstracting (converting) the first model data converted by LLM by the LLM. Therefore, the accuracy of the object-oriented analysis in the model data can be improved. Additionally, in the present embodiment, it is possible to obtain various effects similar to those of the above-described first and second embodiments.

After the conversion from the first model data to the source code and the display, the information processing apparatus 100 may generate the hierarchization prompt using the first model data, input the hierarchization prompt to the LLM, and acquire the second model data. For example, in order to browse the source code displayed on the developer terminal 300 and attempt to abstract the class, the developer may transmit an abstraction request to the information processing apparatus 100 via the developer terminal 300. In this case, the information processing apparatus 100 may perform the processing after the generation of the hierarchization prompt in response to the abstraction request. In this way, the developer can browse the model data and the source code and perform reconversion such as abstraction on the software of a desired version. The developer may correct the model data, designate the corrected model data, and transmit the abstraction request via the developer terminal 300. In this case, the information processing apparatus 100 may perform the processing after the generation of the hierarchization prompt using the designated model data. As described above, the technique according to the present disclosure can support more efficient software development based on object orientation.

### Other Example Embodiments

The above-described information processing apparatus may contain a language model such as an LLM. The language model according to the present disclosure may not be the same at each stage. The technique according to the present disclosure may use, for example, a first language model for converting a required specification sentence into a set of sentences, a second language model for converting the set of sentences into model data subjected to software design based on object orientation, and a third language model for converting the model data into a source code. In this case, the first language model may be a trained model that inputs the required specification sentence and outputs the set of sentences converted from the required specification sentence. The second language model may be a trained model that inputs the set of sentences and outputs the model data subjected to the software design based on object orientation from the set of sentences. The third language model may be a trained model that inputs the model data and outputs the source code. In this case, an instruction sentence in each input text to each language model can be omitted. Some of the first to third language models may be common models.

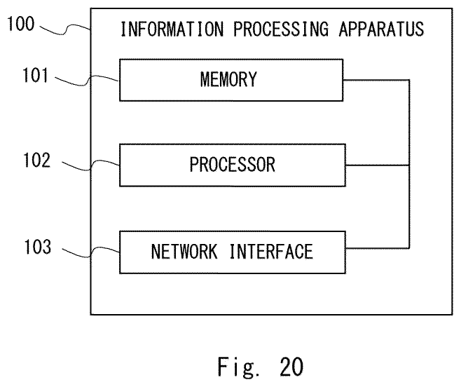

FIG. 20 is a block diagram illustrating a hardware configuration of the information processing apparatus 100 and the like described above. The information processing apparatus 100 includes a memory 101, a processor 102, and a network interface 103.

The memory 101 is configured by a combination of a volatile memory and a nonvolatile memory. The volatile memory is, for example, a volatile storage device such as a random access memory (RAM) and is a storage region where information is temporarily held during operation of the processor 102. The nonvolatile memory is, for example, a nonvolatile storage device such as a hard disk or a flash memory. The memory 101 stores at least a computer program in which processing of an information processing method (software development support method based on object orientation) in the information processing apparatus 100 according to the present disclosure is implemented. The memory 101 may include a storage disposed away from the processor 102. In this case, the processor 102 may access the memory 101 via an input/output (I/O) interface (not illustrated).

The processor 102 is a control device that controls each configuration of the information processing apparatus 100. The processor 102 reads and executes software (computer program) from the memory 101. Accordingly, the processor 102 realizes functions of the reception unit 121, the generation unit 122, the input unit 123, the acquisition unit 124, and the output unit 125. That is, the processor 102 performs processing of an information processing method in the information processing apparatus 100 according to the present disclosure. The processor 102 may be, for example, a microprocessor, a multi processing unit (MPU), or a central processing unit (CPU). The processor 102 may include a plurality of processors.

The network interface 103 may be used to communicate with network nodes. The network interface 103 may include, for example, a network interface card (NIC) conforming to IEEE 802.3 series. IEEE represents Institute of Electrical and Electronics Engineers. The network interface 103 may include a wireless local area network (LAN), a wired LAN, Wi-Fi (registered trademark), Bluetooth (registered trademark), and the like.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note A1

An information processing apparatus comprising:
at least one memory storing instructions; and
at least one processor configured to execute the instructions to;
input, to a predetermined language model, a first input text including a first instruction sentence for converting a required specification sentence in which a required specification of software is described in a natural language into a set of sentences in accordance with a predetermined sentence type and the required specification sentence;
acquire the set of sentences converted from the required specification sentence based on the first instruction sentence by the language model;
input, to the language model, a second input text including a second instruction sentence for converting a set of sentences into model data by a software design method based on object orientation and the set of sentences; and
acquire model data converted from the set of sentences based on the second instruction sentence by the language model.

### Supplementary Note A2

The information processing apparatus according to Supplementary Note A1, wherein the model data is data obtained by converting the set of sentences into information in which components of software based on object orientation and a relationship between the components are defined.

### Supplementary Note A3

The information processing apparatus according to Supplementary Note A2, wherein the model data includes information in which the components determined to have high similarity in logical structure among the components extracted from the set of the sentences by the language model are abstracted, the components are hierarchically structured, and the relationship between the components is defined.

### Supplementary Note A4

The information processing apparatus according to Supplementary Note A2 or A3, wherein the model data includes a class structure in which words included in the set of sentences are associated with each other.

### Supplementary Note A5

The information processing apparatus according to Supplementary Note A2 or A3, wherein
the model data includes a class, a method, an attribute, an argument, and a return value as the components, and
the relationship between the components includes an inheritance relationship between classes, a possession relationship between classes, a correspondence relationship between a class and a method, and a correspondence relationship between a method, an argument, and a return value.

### Supplementary Note A6

The information processing apparatus according to any one of Supplementary Note A1 to A5, wherein the at least one processor is further configured to execute the instructions to;
input, to the language model, a third input text including the model data and a third instruction sentence for converting the model data into a source code based on a specification of a specific programming language; and
acquire the source code converted from the model data based on the third instruction sentence by the language model.

### Supplementary Note A7

The information processing apparatus according to Supplementary Note A1 or A2, wherein the at least one processor is further configured to execute the instructions to;
input, to the language model, a fourth input text including the first model data and a fourth instruction sentence for abstracting a component determined by the language model to have high similarity in a logical structure between the components included in first model data and reconverting the components to have a hierarchical structure, and
acquire, as the model data, second model data reconverted from the first model data based on the fourth instruction sentence by the language model.

### Supplementary Note A8

The information processing apparatus according to any one of Supplementary Note A1 to A7, wherein the set of sentences is converted from the required specification sentence by the language model in accordance with a plurality of basic sentence types in a grammar of a specific natural language.

### Supplementary Note B1

An information processing method causing a computer to execute:
inputting, to a predetermined language model, a first input text including a first instruction sentence for converting a required specification sentence in which a required specification of software is described in a natural language into a set of sentences in accordance with a predetermined sentence type and the required specification sentence;
acquiring the set of sentences converted from the required specification sentence based on the first instruction sentence by the language model;
inputting, to the language model, a second input text including a second instruction sentence for converting a set of sentences into model data by a software design method based on object orientation and the set of sentences; and
acquiring model data converted from the set of sentences based on the second instruction sentence by the language model.

### Supplementary Note C1

A non-transitory computer-readable medium storing a program that causes a computer to execute:
a first input process of inputting, to a predetermined language model, a first input text including a first instruction sentence for converting a required specification sentence in which a required specification of software is described in a natural language into a set of sentences in accordance with a predetermined sentence type and the required specification sentence;
a first acquisition process of acquiring the set of sentences converted from the required specification sentence based on the first instruction sentence by the language model;
a second input process of inputting, to the language model, a second input text including a second instruction sentence for converting a set of sentences into model data by a software design method based on object orientation and the set of sentences; and
a second acquisition process of acquiring model data converted from the set of sentences based on the second instruction sentence by the language model.

Some or all of the elements (for example, configurations and functions) described in supplementary notes A2 to A8 dependent on supplementary note A1 {e.g. apparatus} can also be dependent on supplementary note B1 {e.g. method} and supplementary note C1 {e.g. program} by the same dependency relationship as supplementary notes A2 to A8. Some or all of the elements described in any supplementary note may be applied to various types of hardware, software, recording means for recording software, systems, and methods.

What is claimed is:

1. An information processing apparatus comprising:
at least one memory storing instructions; and
at least one processor configured to execute the instructions to;
input, to a predetermined language model, a first input text including a first instruction sentence for converting a required specification sentence in which a required specification of software is described in a natural language into a set of sentences in accordance with a predetermined sentence type and the required specification sentence;
acquire the set of sentences converted from the required specification sentence based on the first instruction sentence by the language model;
input, to the language model, a second input text including a second instruction sentence for converting the set of sentences into model data by a software design method based on object orientation and the set of sentences; and
acquire model data converted from the set of sentences based on the second instruction sentence by the language model.

2. The information processing apparatus according to claim 1, wherein the model data is data obtained by converting the set of sentences into information in which components of software based on object orientation and a relationship between the components are defined.

3. The information processing apparatus according to claim 2, wherein the model data includes information in which the components determined to have high similarity in logical structure among the components extracted from the set of the sentences by the language model are abstracted, the components are hierarchically structured, and the relationship between the components is defined.

4. The information processing apparatus according to claim 2, wherein the model data includes a class structure in which words included in the set of sentences are associated with each other.

5. The information processing apparatus according to claim 2, wherein
the model data includes a class, a method, an attribute, an argument, and a return value as the components, and
the relationship between the components includes an inheritance relationship between classes, a possession relationship between classes, a correspondence relationship between a class and a method, and a correspondence relationship between a method, an argument, and a return value.

6. The information processing apparatus according to claim 1, wherein the at least one processor is further configured to execute the instructions to;
input, to the language model, a third input text including the model data and a third instruction sentence for converting the model data into a source code based on a specification of a specific programming language; and
acquire the source code converted from the model data based on the third instruction sentence by the language model.

7. The information processing apparatus according to claim 1, wherein the at least one processor is further configured to execute the instructions to;
input, to the language model, a fourth input text including the first model data and a fourth instruction sentence for abstracting a component determined by the language model to have high similarity in a logical structure between the components included in first model data and reconverting the components to have a hierarchical structure, and
acquire, as the model data, second model data reconverted from the first model data based on the fourth instruction sentence by the language model.

8. The information processing apparatus according to claim 1, wherein the set of sentences is converted from the required specification sentence by the language model in accordance with a plurality of basic sentence types in a grammar of a specific natural language.

9. An information processing method causing a computer to execute:
inputting, to a predetermined language model, a first input text including a first instruction sentence for converting a required specification sentence in which a required specification of software is described in a natural language into a set of sentences in accordance with a predetermined sentence type and the required specification sentence;
acquiring the set of sentences converted from the required specification sentence based on the first instruction sentence by the language model;
inputting, to the language model, a second input text including a second instruction sentence for converting the set of sentences into model data by a software design method based on object orientation and the set of sentences; and
acquiring model data converted from the set of sentences based on the second instruction sentence by the language model.

10. A non-transitory computer-readable medium storing a program that causes a computer to execute:
a first input process of inputting, to a predetermined language model, a first input text including a first instruction sentence for converting a required specification sentence in which a required specification of software is described in a natural language into a set of sentences in accordance with a predetermined sentence type and the required specification sentence;
a first acquisition process of acquiring the set of sentences converted from the required specification sentence based on the first instruction sentence by the language model;
a second input process of inputting, to the language model, a second input text including a second instruction sentence for converting the set of sentences into model data by a software design method based on object orientation and the set of sentences; and
a second acquisition process of acquiring model data converted from the set of sentences based on the second instruction sentence by the language model.
